(19) United States
(12) Patent Application Publication
(10) Pub. No.: US 2018/0333669 A1
(43) Pub. Date: Nov. 22, 2018

(54) PACKING AND COLUMN COMPRISING ONE OR MORE PACKINGS

(71) Applicants: ElringKlinger AG, Dettingen (DE); ElringKlinger Kunststofftechnik GmbH, Bietigheim-Bissingen (DE)

(72) Inventor: Katja Widmann, Aalen (DE)

(21) Appl. No.: 16/014,620

(22) Filed: Jun. 21, 2018

Related U.S. Application Data
(63) Continuation of application No. PCT/EP2016/075178, filed on Oct. 20, 2016.

(30) Foreign Application Priority Data
Dec. 22, 2015 (DE) 10 2015 122 523.9
Feb. 12, 2016 (DE) 10 2016 102 506.2

(51) Int. Cl. B01D 46/24; B01D 3/28

(52) U.S. Cl. CPC B01D 46/247; B01D 46/2474; B01D 53/18; B01D 3/28; B01D 46/2429

(57) ABSTRACT

A packing is provided which has an increased corrosion resistance, high chemical resistance, low flow resistance, and an increased service life in comparison with conventional packings, wherein, to this end, it is provided that the packing comprises includes a honeycomb body having first and second end faces, wherein the honeycomb body has a honeycomb structure which has a plurality of flow channels that are arranged substantially in parallel and that are adjacent to each other by means of channel walls, and wherein the honeycomb body is made from a first plastics material based on polytetrafluoroethylene (PTFE) polymer material. Furthermore, a column is proposed which comprises includes a housing that has at least one inlet, at least one outlet and one or more packings according to the invention which are preferably arranged in a flow path running from the inlet to the outlet, in succession if applicable.

### CROSS-REFERENCE TO RELATED APPLICATIONS

This application is a continuation of International Application Number PCT/EP2016/075178, filed Oct. 20, 2016, which claims the benefit of German Application Numbers 10 2015 122 523.9, filed Dec. 22, 2015 and 10 2016 102 506.2, filed Feb. 12, 2016, which are incorporated herein by reference in their entireties and for all purposes.

### FIELD OF THE DISCLOSURE

The invention relates to a packing, in particular for use in columns for a material and possibly energy exchange, comprising a honeycomb body having first and second end faces that are arranged in parallel with one another and a plurality of flow channels for fluid media, said flow channels being arranged in parallel with one another and extending from the first to the second end face. The invention also relates to a column, in particular for use for material and possibly energy exchange, comprising a housing having at least one inlet and at least one outlet and one packing or a plurality of packings arranged in a flow path of the housing extending from the inlet to the outlet.

### BACKGROUND OF THE INVENTION

Packings can be used typically in columns for material and possibly energy exchange, in particular in columns for industrial purposes or fractionating columns. Fractionating columns are processing systems for the separation of fluid material mixtures. Alternatively, packings can be used for the material and possibly energy exchange, for example in exhaust air purification or gas scrubbers, wherein particles of dirt present in gaseous media, such as exhaust air or gas that is to be scrubbed, pass into a scrubbing liquid during the material exchange.

Fluid material mixtures can contain for example liquid and/or gaseous components and also solid particles. With use in columns for material and possibly energy exchange, the packings have to satisfy high demands in respect of flow behaviour of the liquid and/or gaseous components, for example a flow deflection without significant pressure losses at the inlet or outlet into or from a packing.

It is additionally important that a homogeneous distribution of the fluid material mixture is achieved over the entire cross-section of the honeycomb body of the packing, in particular with no flow inhomogeneities along a flow channel or along the surface of an end face.

Packings of the type described in the introduction for use in columns for material and possibly energy exchange are known for example from German patent application DE 197 06 544 A1. The packings described there comprise a plurality of packing layers arranged one above the other. The packing layers are made from preferably corrugated or folded metal sheets. A flow deflection, required in that case, between adjacent packing layers is supported by what is known as an insert between the packing layers. Similarly to the packing layers, the insert has flow channels separated by channel walls.

High-boiling components are often also separated from a material mixture, or heated gases are guided, during the material exchange, along the flow path through the housing of the column, which is why the packings must have a high temperature resistance.

At the same time, good mixing of the fluid components of the material mixture should also be provided, such that the most efficient material exchange possible and, as necessary, also energy exchange can take place in the packings or honeycomb bodies thereof.

Components for supporting the material and energy exchange, in particular the packings, come into regular contact with corrosive gases, liquids or reactive particles of dirt of the material mixtures to be separated. Besides a good temperature resistance, a high corrosion resistance and a high and universal chemical resistance are therefore generally also required of the packing.

Residues of corrosive gases, secondary reaction products and particles of dirt, in particular in the form of solid residues, have to be regularly removed from the packings. For this reason, simple handling and an efficient possibility for cleaning the packings or honeycomb bodies thereof are of great economical importance.

In addition, the packings should have a low susceptibility to contamination, such that the packings do not have to be subjected too frequently to a costly cleaning procedure.

The packings are typically used in columns for material and possibly energy exchange which are operated continuously. In the case of continuously operated columns of this kind, for example a continuously operated fractionating column, a start-up procedure following a period of downtime can last a number of days. When changing packings, costs resulting from the downtime and start-up procedure are therefore incurred in addition to the repair costs and/or replacement costs. For this reason, the packings should have the longest possible service life, such that repairs or component replacement operations only need to be performed after time intervals that are as long as possible.

### SUMMARY OF THE INVENTION

The object of the invention is to propose a packing that overcomes the above-mentioned problems and that can be produced economically.

This object is achieved in accordance with the invention by a packing having the features of claim 1.

Since the honeycomb body of a packing according to the invention is made from a first plastics material based on polytetrafluoroethylene (PTFE) polymer material which has a good temperature resistance and a high chemical resistance, on the one hand the packing according to the invention satisfies the high demands in respect of temperature resistance, and on the other hand a high chemical resistance is also provided.

Furthermore, there is no need for any inserts to be used within the packing for flow deflection in order to attain optimised flow conditions, as is necessary in the prior art, for example in DE 197 06 544 A1. Thus, only one kind of component needs to be used, which in turn reduces the number of different replacement parts that have to be ordered and stored.

The packing according to the invention with a honeycomb body made of a first plastics material based on PTFE polymer material inherently has an anti-adhesive surface, whereby it is less susceptible to contamination than conventional packings made of metal. In addition, the low level of contamination, in particular by solid deposits, can be cleaned off in a residue-free manner, without having to replace the component for a new one.

In contrast to packings made of metal, as known for example from DE 197 06 544 A1, packings according to the invention with honeycomb bodies made from a first plastics material based on PTFE polymer material have a high corrosion resistance, which in combination with the generally high chemical resistance leads to an increased service life of the packings according to the invention.

Since the honeycomb body of the packing according to the invention is formed as a honeycomb structure with flow channels that are arranged substantially in parallel with one another and that extend from the first to the second end face of the honeycomb body and are adjacent to each other by means of channel walls, improved mixing can take place and the flow resistance can be kept small. This effect in combination with the high corrosion resistance and chemical resistance and good temperature resistance leads to optimised conditions, overall, for the separation of the constituents of fluid material mixtures compared to conventional packings.

The honeycomb body preferably has flow channels with free cross-sectional areas, wherein the sum of the free cross-sectional areas is approximately 70 to approximately 92%, in particular approximately 75 to approximately 85% of the area of an end face of the honeycomb body. This has the advantage that on the one hand the flow resistance is reduced and on the other hand an optimised mixing of the components can be facilitated.

The honeycomb body of the packing according to the invention is preferably substantially circular in a cross-section parallel to the first and second end faces. This has the advantage of providing a substantially round flow cross-section, which, in contrast to an angular flow cross-section, avoids inhomogeneities in the flow in corner regions.

In a preferred embodiment the honeycomb body is formed in a number of parts. In this preferred embodiment it comprises two or more segments that extend from the first to the second end face of the honeycomb body and are planar and, as necessary, partially cylindrical. By forming the honeycomb body in segments, facilitated handling can be provided even in the case of a large cross-section of the honeycomb body parallel to the end faces.

In the case that a segment has two planar side walls that meet one another in the corner regions, these side walls of the segment are arranged at a right angle to one another. The installation or replacement of individual segments is made possible, whereas in the case of a one-part honeycomb body the entire honeycomb body has to be replaced in the event of signs of wear or the like.

In the context of the invention a ‘planar side wall’ of a segment is not to be understood to mean a closed and smooth face of the honeycomb body. In the context of the invention ‘planar’ does not mean that the side wall cannot comprise any protrusions and/or recesses. ‘Planar’ or ‘partially cylindrical’ side walls in the sense of the invention are planar or cylindrical-wall-shaped enveloping surfaces.

The individual flow channels of the honeycomb structure are preferably polygonal, in particular rectangular, for example square, pentagonal or hexagonal, as considered in cross-section parallel to the end faces of the honeycomb body. With a construction of this kind of the flow channels a low flow resistance can be provided on the one hand, and a sufficient mixing of the media flowing through can be attained on the other hand.

In the polygonal, in particular in the rectangular, square or hexagonal cross-section of the flow channels, mutually opposed channel walls of a flow channel arranged substantially in parallel are preferably arranged at a spacing from one another of approximately 8 to approximately 20 mm, preferably at a spacing of approximately 11 to approximately 17 mm. The mixing of the components and the flow resistance are thus optimally balanced with one another.

The channel walls are formed in cross-section parallel to the end faces preferably with a height of approximately 5 to approximately 11 mm, in particular with a height of approximately 7 mm to approximately 10 mm.

The channel walls of the flow channels of the honeycomb structure preferably have a thickness of approximately 0.8 mm to approximately 2.1 mm.

In the case of conventional packings, such as those described in DE 197 06 544 A1, merely stacking packing layers above one another or pressing them together can result in an undesirable buckling of the channel walls in the packing layers or the inserts arranged therebetween, which can thus lead to an uncontrolled increased flow resistance. In a preferred embodiment this can be avoided with optimised parameters as described above, such as spacing of the channel walls, their height and thickness, without having to separate the packing into layers and use inserts therebetween.

The first plastics material is processible preferably by a pressing/sintering technique. A subsequent machining can make it possible to adapt the honeycomb body to a specific application.

As appropriate, the first plastics material of the honeycomb body is processible thermoplastically, which is advantageous when producing the honeycomb body.

The first plastics material of the honeycomb body preferably has a thermal conductivity of approximately 0.3 W/(m·K) or more, and/or the first plastics material of the honeycomb body has a specific thermal capacity of approximately 0.9 J/(g·K) or more. This has the advantage that for example reaction heat or process heat that is created during the material exchange can be dissipated through the channel walls of the honeycomb structure, which have good thermal conductivity. In addition, areas in which a higher temperature prevails, or what are known as hot-spots, can be avoided and a sufficiently uniform temperature distribution can be provided over the entire packing.

Particularly preferred first plastics materials have optimised thermal conductivities as a result of fillers, for example approximately 0.43 W/(m·K) with a specific thermal capacity of 1.24 J/(g·K) measured on a material sample with a filler content of 3% by weight of a graphite-based filler C-THERM™002, particle size D50 approximately 38 μm (obtainable from TimCal Graphite & Carbon). These fillers, by means of which the thermal conductivity of the first plastics material can be optimised, will also be referred to hereinafter as heat-conductive pigments.

The PTFE polymer material preferably has a density of approximately 2.0 to approximately 2.2 g/cm³.

In particular, the first plastics material has a temperature resistance of approximately 200° C. or more, in particular approximately 250° C. or more. The packings according to the invention can thus also be used in separation methods having special requirements in which high temperatures of this kind prevail or develop.

The material properties of the first plastics material of the honeycomb body are decisive for the properties of the packing according to the invention.

The first plastics material of the honeycomb body preferably has a tear strength, measured in accordance with EN ISO 12086-2, of approximately 10 to approximately 30 N/mm². This has the advantage that packings withstand mechanical loads without tearing. Improved handling at the time of installation and replacement of packings according to the invention in columns can thus be facilitated. In addition, damage sustained during transport can be reduced.

The first plastics material of the honeycomb body preferably has an elongation at break, measured in accordance with EN ISO 12086-2, of approximately 220 to approximately 350%. Similarly to the improved tear strength, this is also advantageous for the handling during installation, replacement and transport of the packings according to the invention.

The improved mechanical properties of the first plastics material contribute in particular to the fact that packings according to the invention in this preferred embodiment can support high loads and in doing so demonstrate only a minor deflection.

For example, packings according to the invention can be produced with a channel length of the flow channels from the first to the second end face of 100 mm, which, with loose placement at the edge of an open and application of a load of 210 kg, do not experience any deflection, not even at 100° C. or 150° C. Even at a temperature of 200° C. there is merely a deflection of approximately 0.5 mm.

In the case of a packing according to the invention there is no buckling of the channel walls as described in the prior art, not even at a load of 210 kg. Even at a high loading of the packings according to the invention, an additional flow resistance caused by buckled channel walls, which would additionally lead to inhomogeneities as the flow passes through the packing, is thus avoided. Consequently, packings according to the invention in this preferred embodiment have a low flow resistance and uniform flow properties over the entire honeycomb body, even under different process conditions.

It is important that packings have the lowest possible gas permeability relative to reactive, in particular corrosive gases. Gas permeability is specified typically on the basis of a permeation rate of the permeability in cm³ relative to test gases, for area in m², test duration in days d, and for pressure of the gas in bar. The permeation rate is measured for a film of defined film thickness in accordance with DIN 53380 part 2.

The composition of the first plastics material can be adapted to the particular requirements.

In a preferred variant of the first plastics material, in which the PTFE polymer material comprises a high-performance polymer, the first plastics material of the honeycomb body in particular has an improved gas permeability or permeation rate. The permeation rate, measured on the basis of a film having a thickness of 1 mm, for this preferred variant of the first plastics material, comprising a high-performance polymer, is in particular 440 cm³/(m²·d·bar) or less for gaseous HCl. If an even lower gas permeability should be desired, the permeation rate can even be halved with a film that is just 1 mm thicker, or can even be reduced by a factor of 7 or more with an even thicker film, for example of 6 mm.

However, also in the case that the first plastics material in accordance with a further variant is selected from a PTFE polymer material without high-performance polymer, a permeation rate relative to Cl₂, HCl or SO₂ of approximately 620 cm³/(m²·d·bar) or less, in the case of Cl₂ or SO₂ in particular approximately 300 cm³/(m²·d·bar) or less can be attained.

At permeation rates of this kind the amount of a potentially corrosive gas that passes through the channel walls and thus can come into contact with the housing of the column and can cause signs of wear is minimised.

As mentioned in the introduction, mixtures that are to be separated often contain particles of dirt, which can settle in the form of solid deposits on the surface of the honeycomb body or result in accelerated wear. In particular, a surface structure with a high roughness can have an increased susceptibility to contamination.

The surfaces of the channel walls therefore preferably have a surface roughness Rₘₐₓ of approximately 250 μm or less. On the one hand, the flow behaviour can thus be optimised, and on the other hand the susceptibility to contamination can be reduced. The surface roughness is determined in accordance with DIN EN ISO 4288.

The wear of the packing according to the invention is also reduced compared to conventional metallic packings. A wear test with irradiation of the packing according to the invention with corundum with a particle size of approximately 0.2 to approximately 0.8 mm and a pressure of 6 bar resulted in no significant change to the packing, not even after 5 minutes.

In a preferred variant the PTFE polymer material contains virgin grade polytetrafluoroethylene (PTFE) in a proportion of approximately 80% by weight or more and possibly a high-performance polymer different from PTFE in a proportion of approximately 20% by weight or less. The virgin grade PTFE preferably has a comonomer proportion of approximately 1% by weight or less, more preferably approximately 0.1% by weight or less. The virgin grade PTFE with a comonomer proportion will also be referred to hereinafter as virgin grade modified PTFE.

The virgin grade PTFE and as applicable the high-performance polymer different from PTFE more preferably has a mean particle size D₅₀ in the raw state of approximately 10 μm to approximately 600 μm, preferably approximately 250 μm to approximately 450 μm. The mean particle size D₅₀ relates in each case to the mean diameter of the particles.

A suitable virgin grade, non-agglomerated PTFE is for example Inoflon 640 (manufacturer: Gujarat Fluorochemicals Ltd.) with a primary particle size D₅₀ of approximately 25 μm.

The previously described preferred variant of the first plastics material can be welded in particular without welding filler material. This enables facilitated processibility.

In order to adapt the properties of the first plastics material to the respective requirements, the first plastics material preferably contains non-metallic fillers, wherein the non-metallic fillers are selected in particular from PEEK, graphite, carbon, boron nitride and silicon carbide.

In the preferred variant, in which the first plastics material contains non-metallic fillers, the dimensional stability and the abrasion resistance and wear resistance of the honeycomb body can be improved in particular. In addition, the thermal conductivity and the electrical conductivity can be optimised by means of the fillers. Non-metallic fillers based on carbon, in particular based on graphite, carbon or carbon black, these also being referred to as heat-conductive pigments, are particularly preferred.

With regard to the preferred selection of the particle size of the plastics materials to be used in accordance with the invention, the particle size of the fillers in respect of the sought uniform distribution in the plastics material will be approximately 2 μm to approximately 300 μm, preferably approximately 2 μm to approximately 150 μm.

In particular, the non-metallic fillers have a particle size D₅₀ of each particular filler preferably of approximately 100 μm or less.

The non-metallic filler is preferably contained in a proportion of approximately 40% by weight or less in the first plastics material of the honeycomb body.

The filler can preferably be distributed homogeneously in the first plastics material within the scope of a compounding (production of a granular material) of the fillers and the virgin grade or virgin grade, modified PTFE. The non-pourable compound is subjected subsequently to a granulation process in order to produce agglomerated particles. The resultant mean particle size D₅₀ of the agglomerates can be approximately 1 to 3 mm, for example.

The packing according to the invention preferably has a sealing element that is made from a second plastics material based on polytetrafluoroethylene (PTFE) polymer and that extends away from the honeycomb body parallel to the first or second end face of the honeycomb body. The sealing element reduces the flow between packing and housing of the column, such that the housing comes into contact with minimal highly corrosive media or so that media of this kind have low flow rates in the region of the housing wall.

It is sometimes sufficient if the flow between packing and housing of the column is reduced by the sealing element, however the sealing element is in particular formed in a fluid-tight manner.

The sealing element is preferably connected to the honeycomb body with a substance-to-substance bond. It is in particular formed integrally with the honeycomb body. This has the advantage that the best possible seal can be provided.

In an embodiment in which the packing is formed in a number of parts, the sealing element is preferably formed in a number of parts.

As appropriate, the sealing element can be structured such that it stabilises the segments of the honeycomb body in the state installed in the column. This has the advantage that the segments of the honeycomb body are indeed held together, however a clamping ring, as is used typically in metallic packings, is superfluous for the case of installation in columns.

As already mentioned at the outset, the invention additionally relates to a column in particular for use for material and possibly energy exchange, said column comprising a housing having at least one inlet, at least one outlet, and one packing or a plurality of packings according to the invention according to any one of claims 1 to 22. The packing or packings according to the invention is/are arranged in a flow path of the media in the housing running from the inlet to the outlet, in succession if applicable.

The above-mentioned advantages for packings according to the invention apply similarly for columns according to the invention that contain packings of this kind.

The honeycomb body used in the column according to the invention is preferably formed in a number of parts in the form of two or more segments, which extend from the first to the second end face of the honeycomb body and have planar side walls and, as necessary, side walls in the form of a circular arc in cross-section. The segments are arranged adjacent to each other in the housing of the column by means of planar side walls. This multi-part construction facilitates the installation in the column and enables a partial replacement without the entire packing having to be replaced. In addition, the cross-section of the honeycomb body can thus be easily adapted to the required circumference of the packing.

Columns according to the invention can be operated both in co-current flow and in counter-current flow. A continuous or discontinuous operation can additionally be preferred depending on the construction and purpose.

In a preferred embodiment, besides inlets and outlets, the column also comprises an inflow between inlets and outlets, by means of which inflow the mixture that is to be separated is fed.

The segments of multi-part honeycomb bodies of a packing according to the invention are preferably arranged loosely in the housing of the column. This has the advantage that, in contrast to metallic packings, there is no need to use any clamping rings, and therefore a replacement of the packings or individual segments is facilitated.

In a preferred embodiment the column according to the invention comprises two or more packings, which are arranged in succession in the flow path between the inlet and outlet, wherein a spacer having one or more base elements is arranged optionally between the packings. A spacer improves in particular the flow conditions between two packings. There is then no need to align the flow channels of the packings arranged successively in the flow path.

In contrast to the prior art, however, the spacer does not have to cover a large area, and instead a small contact area between the base element or the base elements and the corresponding packing can be sufficient in order to enable the transition of the fluid from one packing to another packing, in particular in a vortex-free manner and without any change to the flow resistance.

The base element or the base elements preferably comprise a block-shaped honeycomb element having a first and a second end face, wherein the honeycomb element comprises a honeycomb structure which has a plurality of flow channels that are arranged substantially in parallel with one another, extend from the first to the second end face, and that are adjacent to each other by means of channel walls, wherein the honeycomb structure is made from a first plastics material based on polytetrafluoroethylene (PTFE), wherein the base element or base elements, at the first or second end face, adjoins/adjoin the corresponding end faces of the corresponding packings. An optimised flow without pressure losses can thus be attained at the transitions between bases and packings or between the individual packings.

The flow channels of the honeycomb structure of the packings and as applicable the flow channels of the honeycomb structure of the base element/elements are preferably arranged in the housing in a manner oriented in parallel with the flow path. An optimised material exchange and an improved mixing of the fluid components can be provided in this orientation of the flow channels.

The base element/base elements is/are preferably connected to the packings in a positively-locking and/or force-locking manner, or it/they is/are formed integrally with the packings.

### BRIEF DESCRIPTION OF THE DRAWINGS

These and further advantages of the invention will be explained in greater detail hereinafter with reference to the drawings. Specifically, the drawings show:

FIG. 1: a first embodiment of a column according to the invention with packings according to the invention;

FIG. 2: a second embodiment of a column according to the invention with packings according to the invention;

FIG. 3: a first embodiment of a packing according to the invention;

FIG. 4: a further embodiment of a packing according to the invention;

FIG. 5: a detail of a column according to the invention with a packing according to the invention;

FIG. 6: a further detail of a column according to the invention with two packings according to the invention;

FIG. 7: a further embodiment of a packing according to the invention.

### DETAILED DESCRIPTION OF THE INVENTION

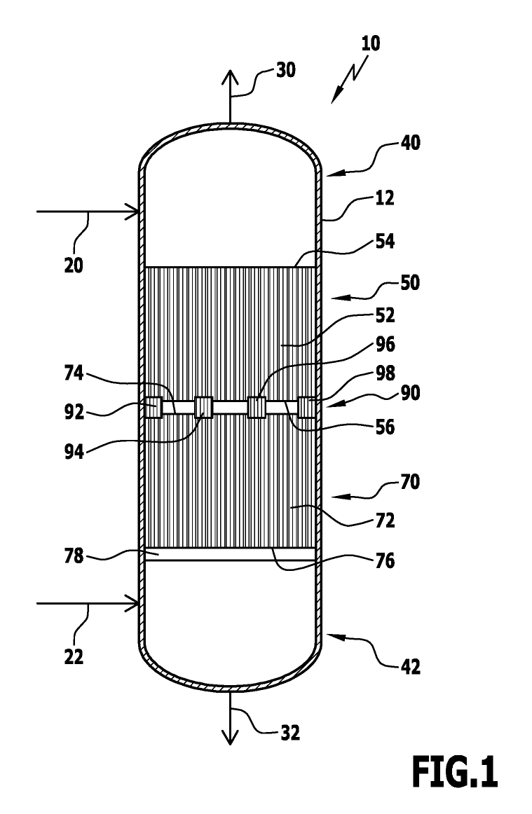

FIG. 1 shows a first embodiment of a column 10 according to the invention with packings 50, 70 according to the invention in a vertical cross-section. The column can be used for material exchange and possibly energy exchange, for example for gas scrubbing. The column 10 comprises a housing 12 with two inlets 20, 22 and two outlets 30, 32, and also two packings 50, 70 that are arranged between the inlets 20, 22 and the outlets 30, 32 and that are arranged in a flow path running from the inlet 22 to the outlet 30. Depending on the use of the column 10, for example when a liquid medium is of interest, the flow path can also run from the inlet 20 to the outlet 32.

The inlet 20 arranged at the top based on the direction of the force of gravity, and/or the outlet 30, is arranged in a head region 40 of the column 10, whereas the inlet 22 arranged at the bottom based on the force of gravity, and/or the outlet 32, is arranged in a sump region 42 of the column 10.

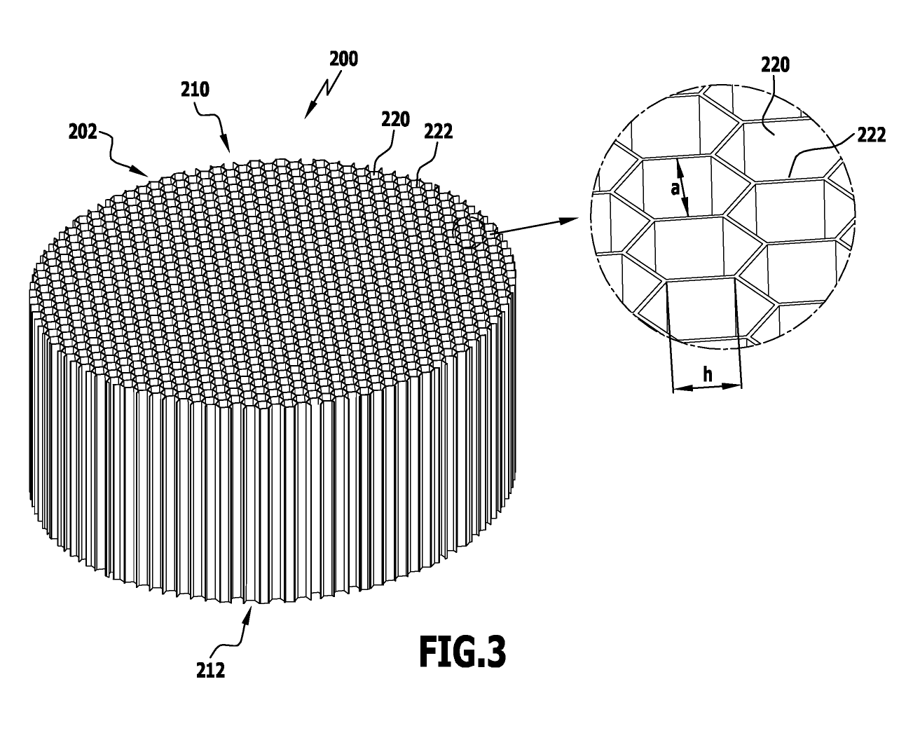

The packings 50, 70 each comprise a honeycomb body 52, 72 having first and second end faces 54, 56, 74, 76 arranged substantially in parallel with one another. The honeycomb bodies 52, 72 further comprise a honeycomb structure with a plurality of flow channels that are arranged in parallel with one another and that are adjacent to each other by means of channel walls. The honeycomb structure is shown in greater detail in FIG. 3. The honeycomb bodies 52, 72 are made from a first plastics material based on a polytetrafluoroethylene (PTFE) polymer material. The packing 70, which is the lower packing based on the force of gravity, is arranged on a supporting edge or supporting grid 78 and is thus held in the column 10 in a stable manner. The supporting edge or the supporting grid here replace the supporting grate that is conventional in the prior art, such that the proportion of material susceptible to corrosion in the interior of the column is minimised. This is possible on account of the high inherent stability of the packing according to the invention with respect to mechanical loads.

A spacer 90 with (shown here) four base elements 92, 94, 96, 98 is arranged optionally between the packings 50, 70. An optimised flow of the fluid material mixture that is to be separated can thus be achieved without pressure losses between the packing 50, 70, and an alignment of the packings in respect of their flow channels in the flow path can be dispensed with.

The base elements 92, 94, 96, 98 preferably each comprise a honeycomb element with first and second end faces arranged substantially in parallel with one another. The honeycomb elements each comprise a honeycomb structure with a plurality of flow channels that are arranged in parallel with one another and that are adjacent to each other by means of channel walls. The honeycomb elements are made from a first plastics material based on PTFE polymer material.

The honeycomb bodies 52, 72 can also be placed in direct contact with one another in the column, without base elements 92, 94, 96, 98, wherein the flow resistance at the mutually opposed end faces of the packings 50, 70 is generally higher.

Due to the anti-adhesive surface and the high chemical resistance of the first plastics material of the packings based on a PTFE polymer material, the packings 50, 70 have a low susceptibility to contamination by solid particles and an increased service life.

In one possible operating mode, which for example can be used in gas scrubbing, a gaseous medium is introduced into the column 10 in the inlet 22 formed in the sump region 42 and flows along the flow path through the packings 50, 70, before it leaves the column 10 again through the outlet 30 in the head region 40 of the column 10.

At the same time, a liquid medium is conducted through the inlet 20 in the head region 40 of the column 10 and flows through the packings 50, 70 against the flow of the gaseous medium in the direction of the force of gravity and leaves the column 10 through the outlet 32 formed in the sump region 42 of the column 10.

In the region of the packings 50, 70, the mixing of the media can be optimised and particles of dirt and contaminations, in particular solid particles, contained in the gaseous medium can pass into the liquid medium and possibly dissolve therein. The gaseous medium thus leaves the column 10 at the outlet 30 in a purified form. With suitable selection of the liquid medium undesired gaseous components in the gaseous medium can also pass into said liquid medium and possibly dissolve therein.

Many other uses are also possible, for example including one in which contaminations pass from the liquid medium into the gaseous medium.

Both continuous operating modes, as described above, and also discontinuous operating modes are possible.

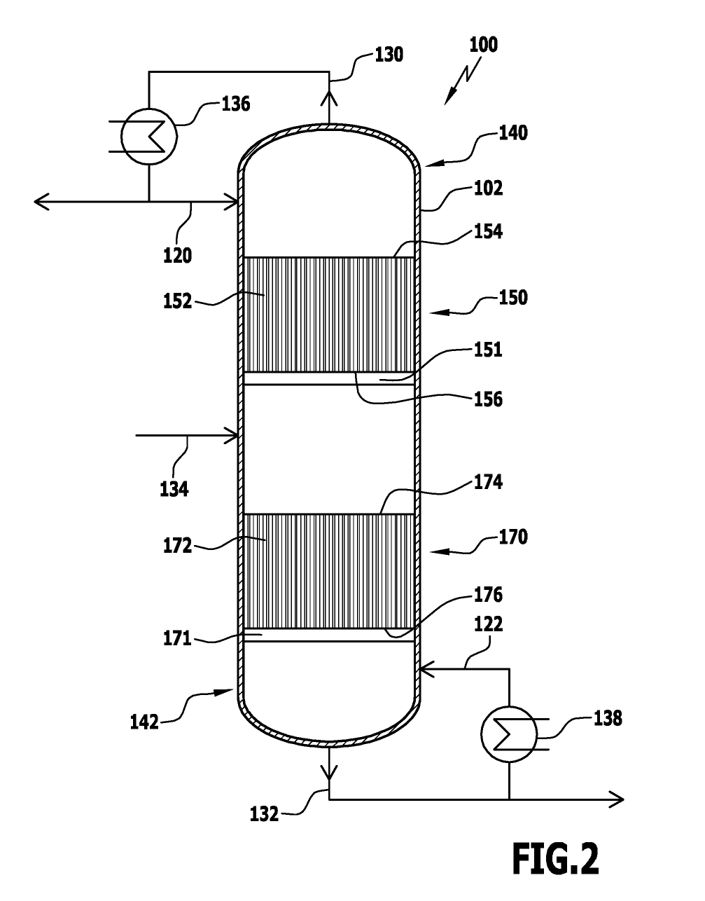

FIG. 2 shows a further embodiment of a column 100 according to the invention in a vertical cross-section. The column 100 can be used for material exchange and possibly energy exchange, for example in columns for industrial purposes and fractionating columns, for separating components in fluid material mixtures.

The column 100 comprises a housing 102 with two inlets 120, 122 and two outlets 130, 132, a further inlet in the form of an inflow 134, and two packings 150, 170 that are arranged between inlets 120, 122 and outlets 130, 132 and that are arranged in a flow path running from the inlet 122 to the outlet 130.

The inlet 120 which is the upper inlet based on the direction of the force of gravity, and/or the outlet 130, is arranged in a head region 140 of the column 100, whereas the inlet 122 which is the lower inlet based on the direction of the force of gravity, and/or the outlet 132, is arranged in a sump region 142 of the column 100. The inflow 134 is arranged between the packings 150, 170.

The packings 150, 170 are each arranged on a supporting grate 151, 171 and each comprise a honeycomb body 152, 172 with first and second substantially parallel end faces 154, 156, 174, 176. The honeycomb bodies 152, 172 further comprise a plurality of flow channels that are arranged in parallel with one another and that are separated from one another by means of channel walls. The flow channels and channel walls are shown in detail in FIG. 3. The honeycomb bodies 152, 172 are made from a first plastics material based on polytetrafluoroethylene (PTFE) polymer material.

In a preferred operating mode the column 100 is operated continuously.

The use of the column 100 as a fractionating column will be described hereinafter by way of example. This example is not to be understood as limiting the use of the column 100 according to the invention.

In continuous operation a liquid material mixture that is to be separated is introduced into the column 100 by means of the inflow 134. The column 100 is preferably heated in order to bring about a thermal separation of higher-boiling and lower-boiling components of the material mixture (not shown). Some of the material mixture is vaporised and rises upwardly in the gaseous state against the force of gravity and accumulates in the head region 140. This portion of the material mixture can be removed in the gaseous state through the outlet 130.

The gaseous portion can contain a proportion of a higher-boiling component of the material mixture. For improved separation the proportion of the higher-boiling component of the liquid material mixture, once it has left the column 100 through the outlet 130 together with the lower-boiling proportion, can be liquefied by means of a condenser 136 and fed back to the head region 140 of the column 100 through the inlet 120.

This liquefied portion of the liquid material mixture then flows downwardly against the direction of the flow path and in the packings 150, 170 contacts the gaseous portion of the material mixture. Due to the geometry of the packing (explained in greater detail in conjunction with FIGS. 3 to 5) the liquid and gaseous proportions are mixed in an optimised manner, such that predominantly the lower-boiling component of the material mixture transitions into the gaseous state by means of material exchange.

In the sump region 142 of the column 100, the higher-boiling component of the material mixture accumulates and can be removed through the outlet 132. For improved separation of the components of the material mixture, the proportion removed through the outlet 132 is heated again by means of an evaporator 138, is brought into the gaseous state as necessary, and is fed back to the column 10 through the inlet 122 in the sump region 142.

The outlets 130, 132 in the head region 140 and sump region 142 respectively can be configured such that samples can be removed from the column 100 during running operation and purity tests can be performed.

FIG. 3 shows an embodiment of a packing 200 according to the invention, in particular for use in columns for the material and possibly energy exchange, in a perspective view. The packing 200 comprises a honeycomb body 202 with first and second substantially parallel end faces 210, 212. The honeycomb body 202 comprises a honeycomb structure with a plurality of flow channels 220 that are arranged in parallel with one another and that are adjacent to each other by means of channel walls 222. The honeycomb body 202 is made from a first plastics material based on polytetrafluoroethylene (PTFE) polymer material. In the present case the honeycomb body 202 is circular in a cross-section parallel to the end faces 210, 212, whereby, in contrast with angular cross-sections, flow inhomogeneities in corner regions are avoided.

The first plastics material has a high chemical resistance and corrosion resistance, and therefore the packing 200 has a long service life, even in the event of contact with corrosive or reactive material mixtures.

In the present case the flow channels 220 are formed parallel to the end faces 210, 212 in a hexagonal cross-section, and mutually opposed channel walls 222 arranged in parallel are formed at a spacing a of approximately 14 mm.

The flow channels have a free cross-sectional area. The channel walls 222 are manufactured in the present case with a thickness of approximately 1.1 mm, and the sum of the free cross-sectional areas of the flow channels lies in a range from approximately 89 to 92% of the area of an end face 210, 212 of the honeycomb body 202. On the one hand the packing 200 has a low flow resistance, and on the other hand good mixing of the components of the material mixture can be attained.

In the present case the channel walls 222 are formed with a height h of approximately 8 mm in a cross-section parallel to the end faces 210, 212 of the honeycomb body 202.

In the present case the honeycomb body 102 has a specific surface area of approximately 75 to 115 m²/m³ and a weight of approximately 400 to 420 kg/m³.

The density of the PTFE polymer material in the present case lies at approximately 2.16 g/cm³, whereby the first plastics material has a high permeation strength.

The surfaces of the channel walls 222 in the present case have a surface roughness Rₘₐₓ of less than 250 μm, whereby the susceptibility to contamination, which is already low anyway, is minimised even further. Thus, hardly any solid particles contained in the material mixture are able to settle on the channel walls 222.

In the present case the PTFE polymer material contains virgin grade PTFE in a proportion of approximately 80% by weight and a high-performance polymer different from PTFE in a proportion of approximately 20% by weight, and the virgin grade PTFE has a comonomer proportion of approximately 0.1% by weight. For example, perfluoro(propyl vinyl ether) (PPVE) is suitable as a high-performance polymer different from PTFE.

The virgin grade PTFE and the virgin grade, modified PTFE for production of the honeycomb body 202 are preferably used in the raw state in agglomerated form with a mean particle size D₅₀ of approximately 250 to 650 μm, particularly preferably of approximately 250 μm to approximately 450 μm.

Virgin grade PTFE and virgin grade, modified PTFE in non-agglomerated form with a particle size D₅₀ of approximately 10 to approximately 200 μm, preferably approximately 25 to approximately 100 μm, can be used for the production of compounds that are then used for the production of the honeycomb body 202.

The first plastics material in the present case, in the case of a specimen having a film thickness of 1 mm, has a permeation rate relative to HCl of approximately 450 cm³/(m²·d·bar). Relative to SO₂ and Cl₂, the permeation rate over 24 h, measured for a film thickness of 1 mm, is approximately 190 cm³/(m²·d·bar) and approximately 180 cm³/(m²·d·bar) respectively. At such a low permeation rate the amount of gas that passes through the channel walls 222 and comes into contact with the housing of the column can be minimised, thus extending the service life of the housing.

The first plastics material preferably has a tear strength of approximately 20 N/mm², measured in accordance with EN ISO 12086-2.

The first plastics material preferably has an elongation at break of approximately 200%, measured in accordance with EN ISO 12086-2.

With properties of this kind, the packing 200 can also withstand high mechanical loads, with only a small amount of wear. The packings can thus also be made more robust in respect of installation or high-pressure cleaning.

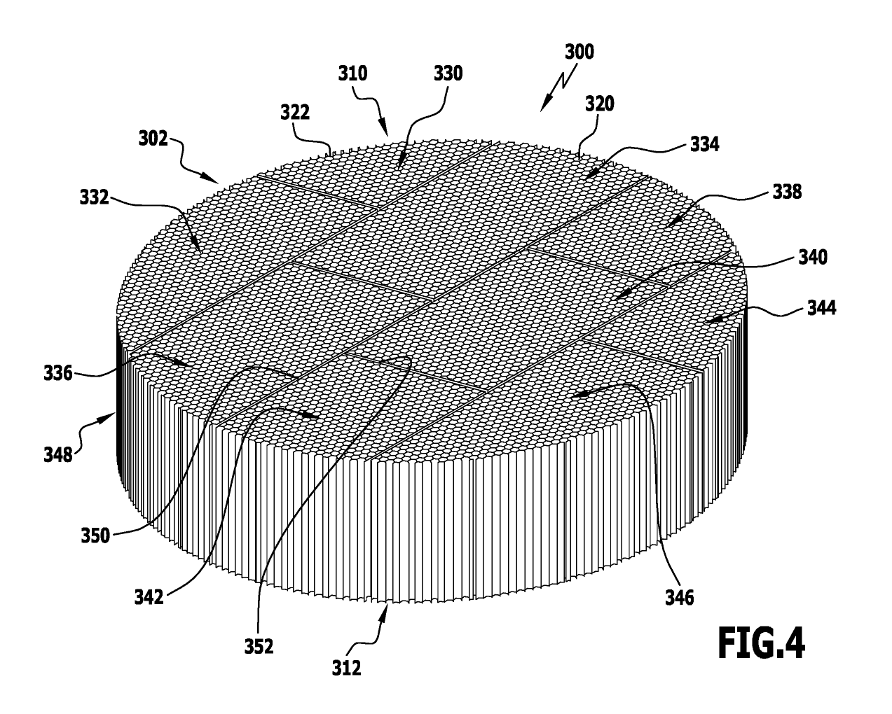

FIG. 4 shows a further embodiment of a packing according to the invention, in particular for use in columns for material and possibly energy exchange, in a perspective view. The packing 300 comprises a honeycomb body 302 with first and second substantially parallel end faces 310, 312. The honeycomb body 302 comprises a honeycomb structure having a plurality of flow channels 320 that are arranged in parallel with one another and that are adjacent to each other by means of channel walls 322. The honeycomb body 302 is made from a first plastics material based on polytetrafluoroethylene (PTFE) polymer material.

In the present case the honeycomb body 302 is circular in a cross-section parallel to the end faces 310, 312, whereby, in contrast with angular cross-sections, flow inhomogeneities in corner regions are avoided.

The flow channels 320 have a hexagonal cross-section, which results in a low flow resistance.

The honeycomb body 302 is formed with the same dimensions and resultant material properties and advantages as the honeycomb body 202 in FIG. 3.

The honeycomb body 302 is formed in a number of parts and in the present case comprises nine segments 330, 332, 334, 336, 338, 340, 342, 344, 346, which extend from the first to the second end face 310, 312 of the honeycomb body 302 and have planar and partially cylindrical side walls (by way of example 348, 350, 352 in the case of segment 342).

Two planar side walls 350, 352, which meet one another in a corner region of a segment 342, are arranged at a right angle to one another. The right-angled orientation facilitates the production of the segments and arrangement thereof so as to form the honeycomb body 300 and makes this more economical than in the case of planar side walls that are arranged at angles to one another deviating from a right angle.

In the present case the first plastics material contains a filler in the form of a heat-conductive pigment. The heat-conductive pigment is contained in a proportion of approximately 3% by weight, based on the proportion by weight of the first plastics material.

The honeycomb body 302 in the present case has a thermal capacity of approximately 1.2 J/(g·K) and a thermal conductivity of approximately 0.4 W//(m·K). Any reaction heat produced during the material exchange can thus be dissipated by means of the packing 300, such that no areas of higher temperature form in the material mixture, and instead the heat is distributed uniformly over the entire packing 300.

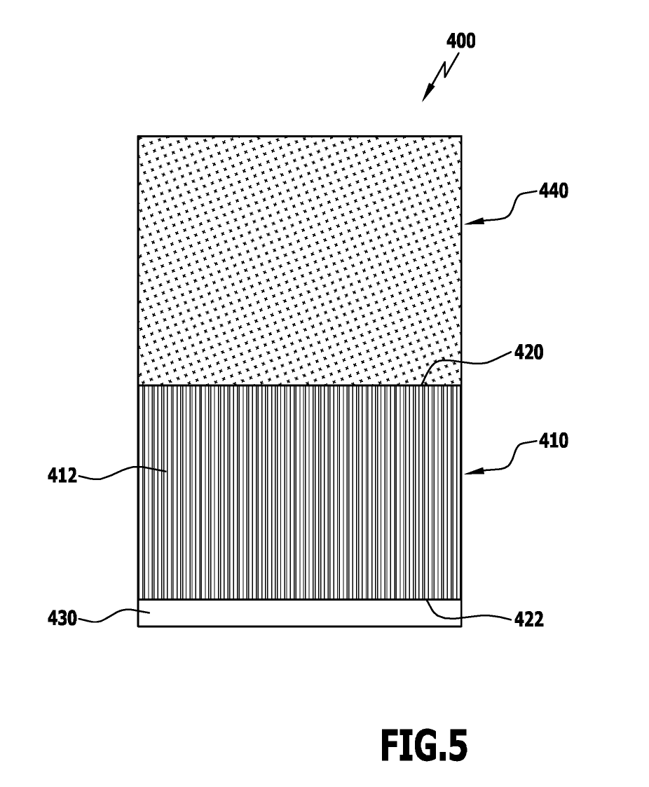

FIG. 5 shows a detail of a further column 400 according to the invention with a packing 410 according to the invention, in a cross-section perpendicular to the end faces of the packing 410. In the detail, the packing 400 according to the invention is shown in the state installed in the column 400. The housing of the column, inlets and outlets, between which the packing 410 is arranged, are not shown here, but can be formed as in FIG. 1 or FIG. 2, for example.

The packing 410 comprises a honeycomb body 412 with first and second end faces 420, 422 arranged in parallel with one another. The honeycomb body 412 comprises a honeycomb structure with flow channels that are arranged substantially in parallel with one another and that are adjacent to each other by means of channel walls and extend from the first end face 420 to the second end face 422. The honeycomb body 410 is made from a first plastics material based on polytetrafluoroethylene (PTFE) polymer material. The honeycomb structure is formed as explained in FIG. 3.

The first plastics material, in the present case, is similar to that described in conjunction with FIG. 3 and has the properties and advantages described there.

The packing is arranged on a supporting grate 430. A layer 440 formed from packing material is stacked loosely above the packing 410.

Whereas the flow resistance is low due to the packing 410 according to the invention and components of the fluid material mixture that is to be separated can mix well, an increased residence time is made possible by the packing material layer 440, for example formed from Raschig rings or Pall rings, and the time spent by the material mixture that is to be separated in the packings 410 according to the invention for material exchange is extended.

Columns as formed in FIG. 1 or FIG. 2 can also be provided, wherein packing material 440 as shown in FIG. 5 is stacked loosely on each of the packings 50, 70, 150, 170 shown in FIGS. 1 and FIG. 2.

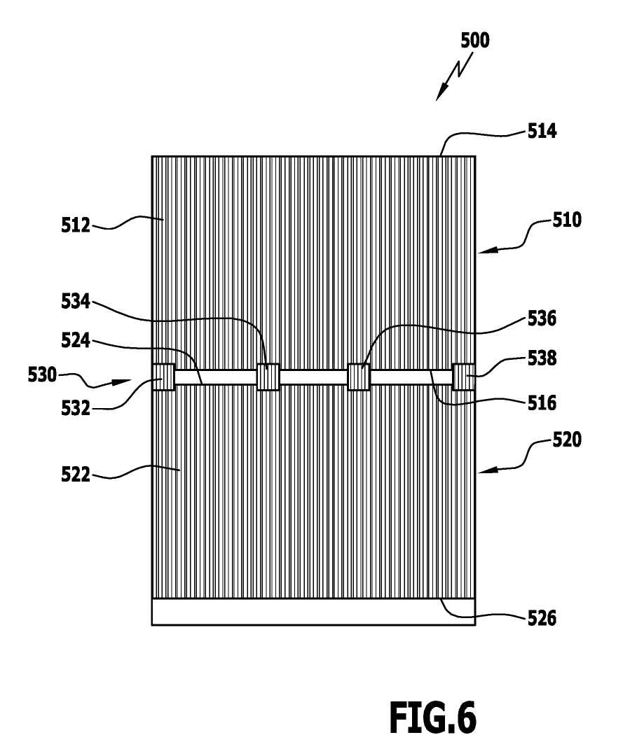

FIG. 6 shows a detail of a column 500 according to the invention with two packings 510, 520 according to the invention each having a honeycomb body 512, 522 with first and second end faces 514, 516, 524, 526 arranged in parallel, in a cross-section perpendicular to these end faces.

The honeycomb bodies 512, 522 each have a honeycomb structure with flow channels that are arranged in parallel with one another and that are adjacent to each other by means of channel walls and are made from a first plastics material based on polytetrafluoroethylene (PTFE) polymer material.

The honeycomb bodies 512, 522 are formed similarly to the honeycomb bodies shown in FIG. 3.

A spacer 530 comprising base elements 532, 543, 536, 538 is arranged between the honeycomb bodies 510, 520.

The base elements 532, 543, 536, 538 are engaged in recesses in the honeycomb bodies 510, 520, said recesses being provided in the shape of the base elements 532, 543, 536, 538, and are supported by means of their end faces on the honeycomb bodies. The structure of the packings 510, 520 of the column 500 is thus stabilised against shifting out of place. In addition, as a result of the base elements 532, 534, 536, 538, a low flow resistance can be achieved at the transition from one packing 510 into the other packing 520 and vice versa, and there is no need for an alignment process for the flow channels of packings arranged in succession.

The base elements 532, 534, 536, 538 each comprise a block-shaped honeycomb element having a first and a second end face, wherein the honeycomb elements of the base elements 532, 534, 536, 538 comprise a plurality of flow channels that are arranged substantially in parallel and that are adjacent to each other by means of channel walls. The honeycomb elements are made from a first plastics material based on PTFE polymer material.

The flow channels of the base elements 532, 543, 536, 538 and the packings 510, 520 are arranged substantially in parallel with the flow path in the column 500 and thus enable a minimal flow resistance.

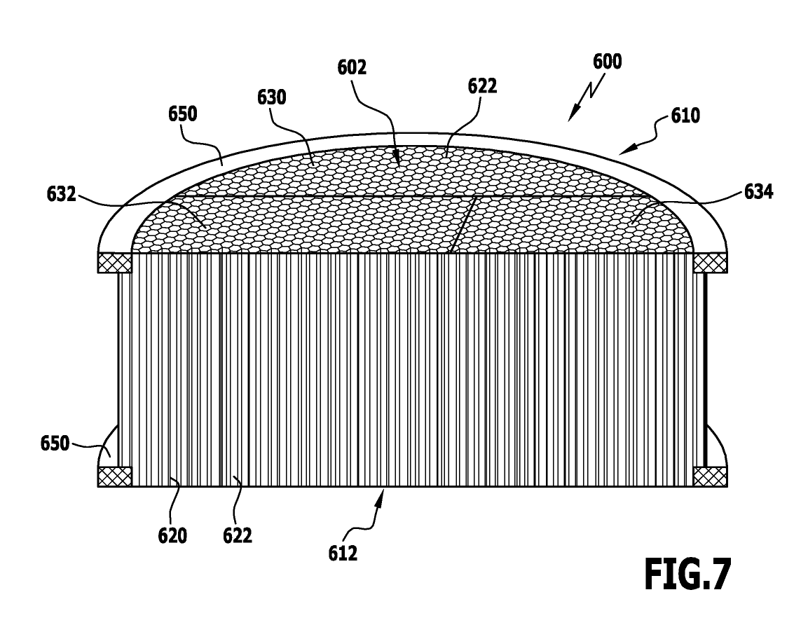

FIG. 7 shows a view of a packing 600 according to the invention. The packing 600 comprises a honeycomb body 602 with first and second end faces 610, 612, and a honeycomb structure with a plurality of flow channels 620 that are arranged in parallel with one another and that are adjacent to each other by means of channel walls 622. The honeycomb body 602 is again made from a first plastics material based on polytetrafluoroethylene (PTFE) polymer material and is formed in a number of parts, with segments 630, 632, 634. The honeycomb body 602 is constructed similarly to the honeycomb body 300 shown in FIG. 4.

The packing 602 also comprises a sealing element 650, which is made from a second plastics material based on polytetrafluoroethylene (PTFE) polymer. The sealing element 650 is arranged parallel to the first end face 610, 612 and extends radially away from the honeycomb body 602. Due to the sealing element 650, the gap between the packing 600 and the wall of the housing of the column (not shown) is reduced or possibly fully closed, and therefore the corrosive material mixtures often flowing therein are kept away from the housing of the column.

The sealing element 650 thus reduces or prevents the flow between housing wall and packing and in particular is fluid-tight.

In the present case the sealing element 650 is connected to the honeycomb body 602 with a substance-to-substance bond, for example by welding, adhesion, etc. However, it can also be connected to the honeycomb body 602 in a force-locking manner.

The sealing element 650 stabilises the segments 650, 632, 634 of the honeycomb body 602 in the assembled state in the column, such that use of a clamping ring, as is standard in the case of conventional metallic packings, is not necessary.

Optionally, as shown in FIG. 7, a sealing ring 650 can be arranged adjacently to both end faces 610, 612 of the honeycomb body 602.

In this multi-part embodiment of the honeycomb body with sealing element 650 as well, packing material can be arranged above the packing 600.

The one or more sealing elements 650 can also be formed in a number of parts as necessary.

1. A packing, in particular for use in columns for material and possibly energy exchange, comprising a honeycomb body having first and second end faces that are arranged substantially in parallel with one another, wherein the honeycomb body comprises a honeycomb structure which has a plurality of flow channels that are arranged in parallel with one another and that are adjacent to each other by means of channel walls, wherein the honeycomb body is made from a first plastics material based on polytetrafluoroethylene (PTFE) polymer material.

2. A packing according to claim 1, wherein the honeycomb body has flow channels that have free cross-sectional areas, wherein the sum of the free cross-sectional areas is approximately 70 to approximately 92%, in particular approximately 75 to approximately 85% of the area of an end face of the honeycomb body.

3. A packing according to claim 1, wherein the honeycomb body is circular in a cross-section parallel to the first and second end faces.

4. A packing according to claim 1, wherein the honeycomb body is formed in a number of parts and comprises two or more segments, which extend from the first to the second end face of the honeycomb body and have planar side walls and optionally side walls in the form of a circular arc, wherein, in the case that a segment has two planar side walls which meet one another in a corner region of the segment, these side walls of the segment are arranged at a right angle to one another.

5. A packing according to claim 1, wherein the individual flow channels of the honeycomb structure, as considered parallel to the end faces of the honeycomb body, are formed with a polygonal, in particular rectangular, square, pentagonal or hexagonal cross-section.

6. A packing according to claim 5, wherein in the polygonal, in particular in the rectangular, square or hexagonal cross-section of the flow channels, mutually opposed channel walls of a flow channel arranged substantially in parallel are arranged at a spacing from one another of approximately 8 to approximately 20 mm, preferably at a spacing of approximately 11 to approximately 17 mm.

7. A packing according to claim 1, wherein the channel walls, in a cross-section parallel to the end faces of the honeycomb body, are formed with a height of approximately 5 to approximately 11 mm, more preferably with a height of approximately 7 to approximately 10 mm.

8. A packing according to claim 1, wherein the channel walls of the flow channels of the honeycomb structure have a thickness of approximately 0.8 mm to approximately 2.1 mm.

9. A packing according to claim 1, wherein the first plastics material is processible in a pressing/sintering method or thermoplastically.

10. A packing according to claim 1, wherein the first plastics material of the channel walls has a thermal conductivity of approximately 0.3 W/(m·K) or more, and/or in that the first plastics material of the channel walls has a specific thermal capacity of approximately 0.9 J/(g·K) or more.

11. A packing according to claim 1, wherein the PTFE polymer material has a density of approximately 2.0 to approximately 2.2 g/cm³.

12. A packing according to claim 1, wherein the first plastics material of the channel walls has a temperature resistance of approximately 200° C. or more, in particular approximately 250° C. or more.

13. A packing according to claim 1, wherein the first plastics material of the channel walls has a tear strength, measured in accordance with EN ISO 12086-2, of approximately 10 to approximately 30 N/mm².

14. A packing according to claim 1, wherein the first plastics material of the channel walls has an elongation at break, measured in accordance with EN ISO 12086-2, of approximately 160 to approximately 350%.

15. A packing according to claim 1, wherein the first plastics material of the channel walls has a permeation rate relative to Cl₂, HCl and/or SO₂ of approximately 620 cm³/(m²·d·bar) or less, and in particular relative to Cl₂ and/or SO₂ of approximately 300 cm³/(m²·d·bar) or less.

16. A packing according to claim 1, wherein the surfaces of the channel walls have a surface roughness Rₘₐₓ of approximately 250 μm or less.

17. A packing according to claim 16, wherein the PTFE polymer material contains virgin grade polytetrafluoroethylene (PTFE) in a proportion of approximately 80% by weight or more and optionally a high-performance polymer different from PTFE in a proportion of approximately 20% by weight or less, wherein the virgin grade PTFE preferably has a comonomer proportion of approximately 1% by weight or less, more preferably approximately 0.1% by weight or less.

18. A packing according to claim 17, wherein the virgin grade PTFE and optionally the high-performance polymer different from PTFE for producing the honeycomb body has, in the raw state, a mean particle size D₅₀ of approximately 10 μm to approximately 600 μm, preferably approximately 250 μm to approximately 450 μm.

19. A packing according to claim 1, wherein the first plastics material contains non-metallic fillers, wherein the non-metallic fillers are selected in particular from PEEK, graphite, carbon, boron nitride and silicon carbide.

20. A packing according to claim 1, wherein the metallic and/or non-metallic fillers have a particle size D₅₀ of approximately 100 μm or less, and in that the non-metallic filler preferably is contained in a proportion of approximately 40% by weight or less in the first plastics material of the honeycomb body.

21. A packing according to claim 1, wherein the packing has a sealing element made from a second plastics material based on polytetrafluoroethylene (PTFE) polymer, wherein the sealing element preferably extends away from the honeycomb body, parallel to the first or second end face of the honeycomb body.

22. A packing according to claim 21, wherein the sealing element is connected to the honeycomb body with a substance-to-substance bond, in particular is formed integrally with the honeycomb body.

23. A column, in particular for use for material and possibly energy exchange, comprising a housing having at least one inlet, at least one outlet, and one packing or a plurality of packings according to claim 1 arranged between the inlet and outlet, said packing or packings preferably being arranged in a flow path for a fluid running from the inlet to the outlet, in succession if applicable.

24. A column according to claim 23, wherein the honeycomb body is formed in a number of parts in the form of two or more segments, which extend from the first to the second end face of the honeycomb body and have planar side walls and optionally side walls in the form of a circular arc, wherein the segments are arranged adjacent to each other in the housing by means of planar side walls.

25. A column according to claim 24, wherein the segments of the packing are arranged loosely in the housing.

26. A column according to claim 23, wherein the material exchanger comprises two or more packings, which are arranged in succession in the flow path, wherein a spacer having one or more base elements is arranged optionally between the packings.

27. A column according to claim 26, wherein the base element or base elements comprise a block-shaped honeycomb element having a first and a second end face, wherein the honeycomb element comprises a honeycomb structure which has a plurality of flow channels that are arranged substantially in parallel with one another and that are adjacent to each other by means of channel walls, wherein the honeycomb element is made from a first plastics material based on polytetrafluoroethylene (PTFE) polymer material, and wherein the base element or base elements is/are supported at the first and second end face on the corresponding end faces of the packings.

28. A column according to claim 23, wherein the flow channels of the honeycomb structure of the packings and optionally the flow channels of the honeycomb structure of the base elements are arranged in the housing in a manner oriented substantially parallel to the flow path.

29. A column according to claim 23, wherein the base or the bases is/are connected to a packing in a positively-locking or force-locking manner, or in that it/they is/are formed integrally with a packing.
